(19) United States
(12) Patent Application Publication
(10) Pub. No.: US 2025/0389384 A1
(43) Pub. Date: Dec. 25, 2025

(54) DEVICE FOR COLLECTING AND STORING AUTOMOTIVE FLUIDS

(71) Applicant: TRADECO PACIFIC INCORPORATED, HONOLULU, HI (US)

(72) Inventor: Joseph Dennis SHIMKONIS, HONOLULU, HI (US)

(73) Assignee: TRADECO PACIFIC INCORPORATED, HONOLULU, HI (US)

(21) Appl. No.: 19/247,577

(22) Filed: Jun. 24, 2025

Related U.S. Application Data
(60) Provisional application No. 63/663,662, filed on Jun. 24, 2024.
(60) Provisional application No. 63/678,835, filed on Aug. 2, 2024.
(60) Provisional application No. 63/735,880, filed on Dec. 18, 2024.
(60) Provisional application No. 63/755,207, filed on Feb. 6, 2025.

(51) Int. Cl. F16N 31/00

(52) U.S. Cl. CPC F16N 31/004

(57) ABSTRACT

A device for collecting and storing fluid includes a fluid collection container having a bottom surface with a drain opening, sidewalls, and an open top. The device also includes a tubular member having a proximal end that includes a fluid inlet, a proximal section, a distal section, a distal end, an outer diameter, and a plurality of sidewall outlet openings in the distal section. The device further includes a fluid storage container having an interior surface, an exterior surface, an inlet opening, and an interior receptacle fixedly coupled to the interior surface. The interior receptacle is configured for coupling with the distal end of the tubular member and is aligned with the inlet opening so that the tubular member, when coupled to the interior receptacle, protrudes out of the inlet opening. The inlet opening has an inner diameter that is larger than the outer diameter of the tubular member.

### CROSS-REFERENCE TO RELATED APPLICATIONS

This Application claims priority to U.S. Provisional Patent Application No. 63/663,662 filed on Jun. 24, 2024, entitled “Fluid Collection Bag with Drain Tray,” the contents of which are incorporated herein by reference. This Application further claims priority to U.S. Provisional Patent Application No. 63/678,835 filed on Aug. 2, 2024, entitled “Fluid Collection Bag with Drain Tray,” the contents of which are incorporated herein by reference. Still further, this Application claims priority to U.S. Provisional Patent Application No. 63/735,880 filed on Dec. 18, 2024, entitled “Fluid Collection Bag with Drain Receptacle Having a Spout,” the contents of which are incorporated herein by reference. This Application further claims priority to U.S. Provisional Patent Application No. 63/755,207 filed on Feb. 6, 2025, entitled “Used Fluid Collection Bag with Drain Tray,” the contents of which are incorporated herein by reference.

### BACKGROUND

### Field of the Art

The present disclosure is related to the field of automotive maintenance, focusing on innovative solutions for fluid collection and recycling in the automotive industry. For example, the present disclosure pertains to the collection and proper disposal or recycling of an automobile's lubrication, coolant, or braking fluid.

### Discussion of the State of the Art

Automotive maintenance often requires the draining and replacement of various fluids such as engine oil, coolant, or brake fluid. The collection and disposal of these fluids presents several challenges. Traditional methods of fluid collection and disposal are often messy, inconvenient, and environmentally unfriendly.

One of the common devices used for fluid collection is rigid oil drain pans. These pans are typically made of metal or injection-molded plastic and are designed to collect the fluids as they are drained from the vehicle. However, these pans present several problems. First, due to their rigid nature, they are bulky and cumbersome, making them difficult to transport to a recycling center for proper disposal of the collected fluids. This leads to a high likelihood of spills and leaks during transportation, which can cause environmental contamination and safety hazards.

Additionally, the storage of these rigid oil drain pans presents another challenge. Because they cannot be collapsed or folded, they require a significant amount of storage space. This can be particularly problematic for individuals with limited storage space, such as those living in apartments or urban areas.

Another method that has been used to address these issues involves the use of a special oil crankcase drain pan bolt that acts as an on/off valve. This valve is connected to a hose, which is in turn connected to a plastic container. When the valve is opened, the oil drains from the crankcase, through the hose, and into the container. While this method can help to reduce the mess associated with oil changes, it also has several limitations.

First, this method is relatively expensive, as it requires the purchase of a specialized valve and container. Additionally, the valve must be fitted to the oil pan's drain screw, which can be a complex and time-consuming process. This method also does not provide a solution for the collection and disposal of other automotive fluids, such as coolant or brake fluid, which limits its usefulness.

In summary, the existing methods for the collection and disposal of automotive fluids are fraught with problems. They are inconvenient and messy, require a significant amount of storage space, are difficult to transport, and/or are limited in their applicability. Therefore, there is a need for a more effective solution to these problems.

### SUMMARY

The present invention provides a solution to the collection and disposal of various automotive fluids such as engine oil, transmission fluid, gear oil, brake fluid, and antifreeze. It is designed for individuals who perform their own automotive maintenance and is aimed at facilitating the collection of these fluids for reuse or recycling in an environmentally responsible manner.

The present invention is thus directed to a device for collecting and storing fluids. The device includes a fluid storage container that is made of a flexible, nonporous material that unfolds, unfurls, expands, or otherwise changes shape by itself when liquid is added thereto. The fluid storage container has an inlet opening and an interior receptacle fixedly coupled to the interior surface of the fluid storage container. The interior receptacle is configured to connect to a tubular member having a fluid inlet and a plurality of outlet openings. Fluid is added to the fluid storage container by flowing through the fluid inlet of the tubular member, out of the outlet openings of the tubular member, and into the fluid storage container to which the tubular member is coupled. The device may further include a fluid collection container having an open top end and drain opening. Collected fluid may flow through the open top end of the fluid collection container and out of the drain opening, which directs the collected fluid into the fluid inlet of the tubular member. In one example, the proximal end of the tubular member is fixedly coupled to the drain opening of the fluid collection container.

The fluid collection and storage device in accordance with the present invention has several advantages. Firstly, it provides a lightweight, compact solution for the collection and disposal of automotive fluids, overcoming the limitations of traditional, rigid oil drain pans. Secondly, the self-expanding nature of the fluid storage container and the integrated fluid collection container offer a clean, mess-free solution for fluid collection and storage, reducing the risk of environmental contamination and safety hazards. Furthermore, the compact design of the device makes it easy to transport and store, addressing the challenges faced with bulky, rigid pans.

In one example, the invention is a device for collecting and storing fluid, where the device includes a fluid collection container having a bottom surface, sidewalls, an open top, and a drain opening extending through the bottom surface. The fluid collection container may be collapsible such that the fluid collection container may have a collapsed configuration and an unfolded, open configuration.

The device further includes a tubular member having a proximal end comprising a fluid inlet, a proximal section, a distal section, a distal end, an outer diameter, and a plurality of sidewall outlet openings in the distal section. The tubular member may include a tubular member flange on the proximal end and an externally threaded section in the proximal section adjacent to the tubular member flange. The device may further include an attachment coupling comprising an attachment coupling flange and an internally threaded section adjacent to the attachment coupling flange. The internally threaded section may be configured to screw onto the externally threaded section of the tubular member. When the tubular member and the fluid collection container are assembled for use, the tubular member may protrude out of the drain opening, the tubular member flange may be in direct contact with the bottom surface of the fluid collection container, and the internally threaded section of the attachment coupling may be coupled to the externally threaded section of the tubular member with a portion of the bottom surface of the fluid collection container sandwiched between the tubular member flange and the attachment coupling flange.

Still further, the device includes a fluid storage container having an interior surface, an exterior surface, an inlet opening, and an interior receptacle fixedly coupled to the interior surface. For example, the interior receptacle may be heat fused to the interior surface of the fluid storage container. The interior receptacle is configured for coupling with the distal end of the tubular member. The interior receptacle is aligned with the inlet opening so that the tubular member, when coupled to the interior receptacle, protrudes out of the inlet opening. The inlet opening has an inner diameter that is larger than the outer diameter of the tubular member. The fluid storage container may be made of a flexible material and may be configured to move between a collapsed configuration and an expanded configuration. There may be a gap between the inlet opening of the fluid storage container and the outer diameter of the tubular member when the tubular member is coupled to the interior receptacle, and the gap may be configured for allowing air to pass therethrough during filling of the fluid storage container. The fluid storage container may be a bag made of a non-porous flexible material, such that a shape of the bag is configured to adjust as fluid is added to or removed from the bag. The non-porous flexible material may be polyethylene, metallized biaxially oriented polyethylene terephthalate film, polyester film. or coated paper. The interior receptacle may include an interior receptacle flange that may be directly coupled to the interior surface of the fluid storage container, and a cylindrical holder member protruding from the interior receptacle flange. The distal end of the tubular member may be configured to fit within the cylindrical holder member.

In another example, the invention is a device for collecting and storing fluid, where the device includes a tubular member having a proximal end comprising a fluid inlet, a proximal section, a distal section, a distal end, an outer diameter, and a plurality of sidewall outlet openings in the distal section. The device further includes a fluid storage container made of a nonporous flexible material configured to change shape as fluid is added to the fluid storage container. The fluid storage container includes an interior surface, an exterior surface, an inlet opening, and an interior receptacle fixedly coupled to the interior surface. For example, the interior receptacle may be heat fused to the interior surface of the fluid storage container. The interior receptacle is configured for coupling with the distal end of the tubular member. The inlet opening has an inner diameter that is larger than the outer diameter of the tubular member such that the inlet opening is configured to rise relative to the tubular member as fluid is added to the fluid storage container. There may be a gap between the inlet opening of the fluid storage container and the outer diameter of the tubular member when the tubular member is coupled to the interior receptacle, such that air may pass through the gap during filling of the fluid storage container. The device may further include a fluid collection container having an open top and a drain opening. The fluid collection container may be configured to direct collected liquid through the drain opening and into the fluid inlet of the tubular member.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIGS. 1A and 1B illustrate a fluid collection and storage device in an assembled state with the fluid storage container in a collapsed configuration and an expanded configuration, respectively, in accordance with an aspect of the present invention.

FIG. 2 is a perspective view of a fluid collection container, in accordance with an aspect of the present invention.

FIG. 3 is a perspective view of a tubular member, in accordance with an aspect of the present invention.

FIG. 4 is a perspective view of an attachment coupling, in accordance with an aspect of the present invention.

FIGS. 5A-5D illustrate steps for assembling a tubular member and a fluid collection container together, in accordance with an aspect of the present invention.

FIGS. 6A and 6B are perspective views of a fluid storage container, in accordance with an aspect of the present invention.

FIG. 7 is a perspective view of an interior receptacle that is configured to be attached to the inside of the fluid storage container, in accordance with an aspect of the present invention.

FIG. 8 illustrates a gap between a tubular member and an inlet opening of the fluid storage container, in accordance with an aspect of the present invention.

### DETAILED DESCRIPTION

The present invention is for a system for the collection and storage or disposal of automotive fluids. The system includes a fluid collection container that couples to a fluid storage container through a tubular member that has a plurality of sidewall openings for dispersing the fluid into the fluid storage container. The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Apparatus

The present invention is for a comprehensive fluid collection apparatus designed for individuals engaged in DIY automotive maintenance. The apparatus is designed to facilitate the efficient collection and recycling, storage, and/or disposal of various automobile fluids. The apparatus includes a fluid collection container for capturing fluid as it drains out of the automobile, a collapsible fluid storage container, and a tubular member for connecting the fluid collection container to the fluid storage container. The fluid collection and storage apparatus can be stored and shipped in a disassembled state.

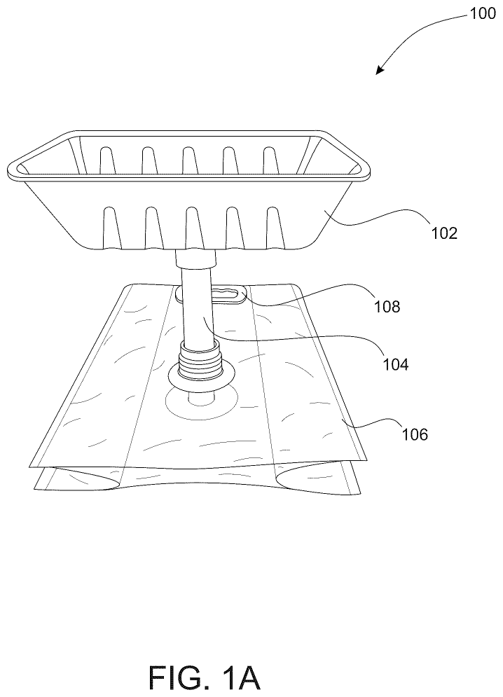

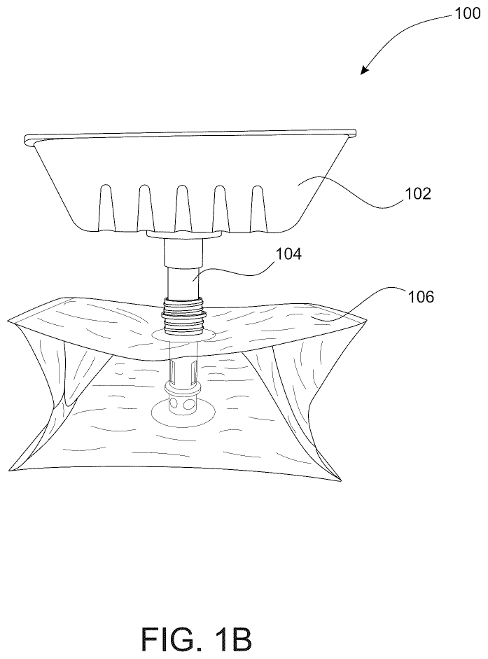

FIGS. 1A and 1B show the apparatus 100 in an assembled state. The apparatus 100 includes the fluid collection container 102, the tubular member 104, and the fluid storage container 106. The fluid storage container 106 may be a bag or a similarly flexible container that is configured to move between a collapsed configuration and an expanded configuration. FIG. 1A depicts the fluid storage container 106 in a substantially collapsed configuration. As fluid is added to the container 106, the container 106 expands, unfurls, unfolds, and/or changes shape to accommodate the fluid. FIG. 1B shows the fluid storage container 106 in an expanded configuration. For ease of transport, the fluid storage container 106 may include a handle 108.

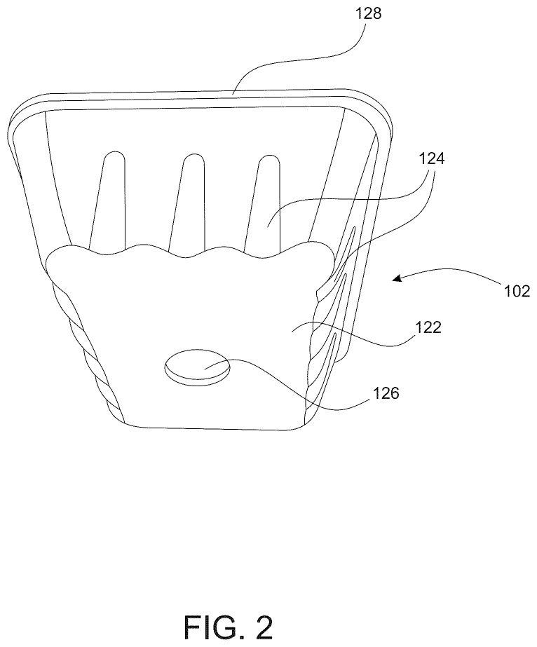

The fluid collection container 102, shown in more detail in FIG. 2, includes a bottom surface 122, sidewalls 124, a drain opening 126 extending through the bottom surface 122, and an open top 128. The fluid collection container 102 is thus configured for capturing fluid as the fluid drains out of a vehicle and directing the captured fluid through the drain opening 126. The fluid collection container 102 may be made of a lightweight, non-porous, water-tight, heat resistant material such as plastic, foam, coated paper, or the like. In one example, the fluid collection container 102 may be foldable or collapsible for storage and shipping. As such, the fluid collection container 102 may have a folded or collapsed configuration and an unfolded or expanded configuration. The fluid collection container 102 is in the unfolded or expanded configuration during use.

Although the fluid collection container 102 is depicted as having a rectangular shape and a flat bottom 122, the apparatus 100 is not limited to this shape and arrangement for the fluid collection container 102. The fluid collection container 102 may have other shapes, such as round, oval, square, or the like. Further, the fluid collection container 102 may have a sloped bottom surface leading to the drain opening 126 such that liquid collected in the container 102 may flow towards the drain opening 126. In another example, the fluid collection container 102 may have a wide top and a narrow bottom for guiding the fluid into the tubular member 104.

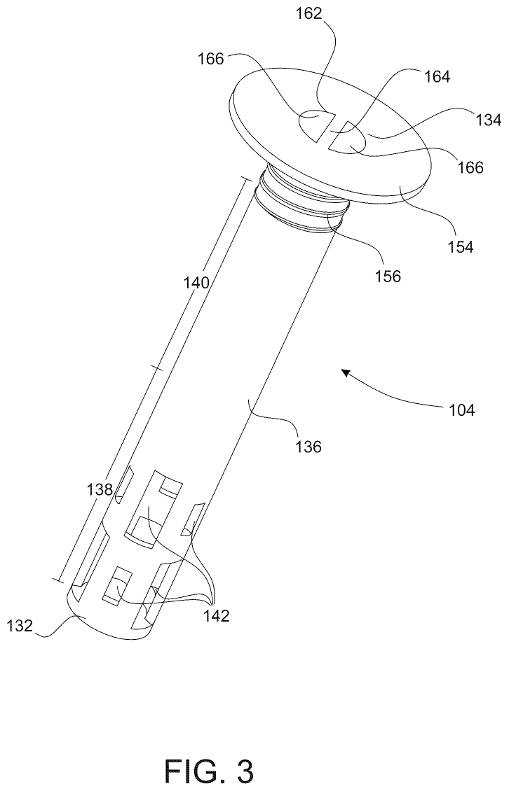

The tubular member 104, depicted in more detail in FIG. 3, has a distal end 132, a proximal end 134, and a tubular sidewall 136 extending between the distal end 132 and the proximal end 134. The tubular member 104 is hollow so that fluid may flow therethrough. The central opening that extends through the tubular member may have a circular cross-sectional shape, as shown, or may alternatively have a different cross-sectional shape, such as square, triangular, oval, hexagonal, or the like. Further, the length of the tubular member 104 may be fixed or adjustable. For example, the tubular member 104 may be collapsible for case of shipping and storage. The collapsible tubular member 104 may include telescoping pieces or pieces that are removably coupled together.

The main body of the tubular member 104 has a distal section 138 and a proximal section 140. The proximal end 134 includes an inlet opening 162 and the distal section 138 includes a plurality of outlet openings 142. The outlet openings 142 extend through the sidewall 136 in the distal section 138 of the tubular member 104. The outlet openings 142 are proximal to the distal end 132. The outlet openings 142 allow fluid to exit the tubular member 104 quickly so that the fluid collection container 102 does not overflow. The number and size of outlet openings 142 may be increased to increase the rate of fluid flow through the tubular member 104 or may be decreased to decrease the rate of fluid flow through the tubular member 104. Although the outlet openings 142 are depicted as having rectangular shapes, it will be readily understood that the invention is not limited to this shape and arrangement of the outlet openings 142. Rather, the outlet openings 142 may be round, square, triangular, hexagonal, or the like, or a combination thereof. The outlet openings 142 are sized and positioned so that, when the tubular member 104 is coupled to the interior receptacle of the fluid storage container, the outlet openings 142 are positioned inside of the fluid storage container 106 so that fluid flowing through the tubular member 104 is captured in the fluid storage container 106 upon exiting the tubular member 104.

The inlet opening 162 in the proximal end 134 of the tubular member 104 is partially closed or blocked by a bar, grate, or lattice structure 164 defining a plurality of openings 166. The plurality of openings 166 allow fluid, such as waste oil, to flow into the tubular member 104, while preventing larger elements (e.g., oil drain plugs, filters, etc.) from falling into or blocking the inlet opening 162. The grate 164 may be fixed in place or may be removable. The plurality of openings 166 are not limited to the size and shape depicted and may have any size and shape that is effective for allowing liquids to flow therethrough.

In one example, the distal end 132 of the tubular member 104 may be closed so that fluid exits the tubular member 104 through the sidewall openings 142 but not through the distal end 132. The closed distal end may increase the stability of the assembled apparatus 100.

The proximal end 134 is configured for being coupled to the drain opening 126 in the fluid collection container 102 such that collected fluid is directed through the drain opening 126 and into the tubular member 104. The proximal end 134 of the tubular member 104 may be coupled to the drain opening 126 using any known coupling mechanism. For example, the fluid collection container 102 may include a spout protruding from the drain opening 126 that can be coupled to the tubular member 104 by snap fit, friction fit, threaded engagement, twist and lock, or the like.

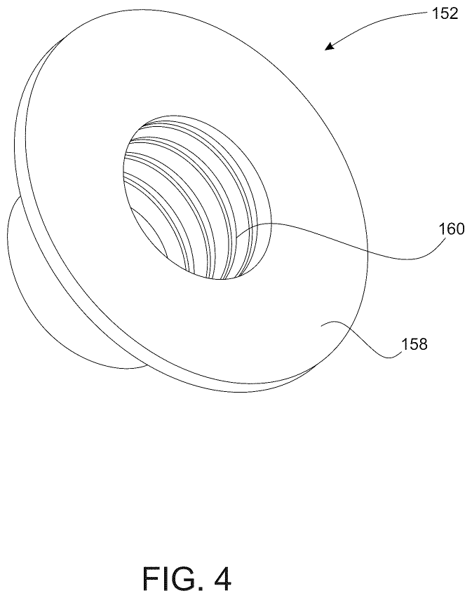

In one example, the tubular member 104 is coupled to the fluid collection container 102 using an attachment coupling 152 such as that shown in FIG. 4. In this example, the tubular member 104 includes an annular flange 154 on the proximal end 134 and an external threaded section 156 adjacent to the annular flange 154. The attachment coupling 152 includes an annular flange 158 and an inner surface 160 that includes corresponding threads such that the attachment coupling 152 is configured to screw onto the external threaded section 156 of the tubular member 104. Although the annular flanges 154, 158 are depicted as having circular cross-sectional shapes, it will be readily understood that the invention is not limited to this shape and size for the flanges 154, 158. The flanges 154, 158 may have cross-sectional shapes that are square, triangular, rectangular, oval, hexagonal, or the like, and may have sizes that are bigger or smaller than the sizes depicted in FIGS. 3-5D.

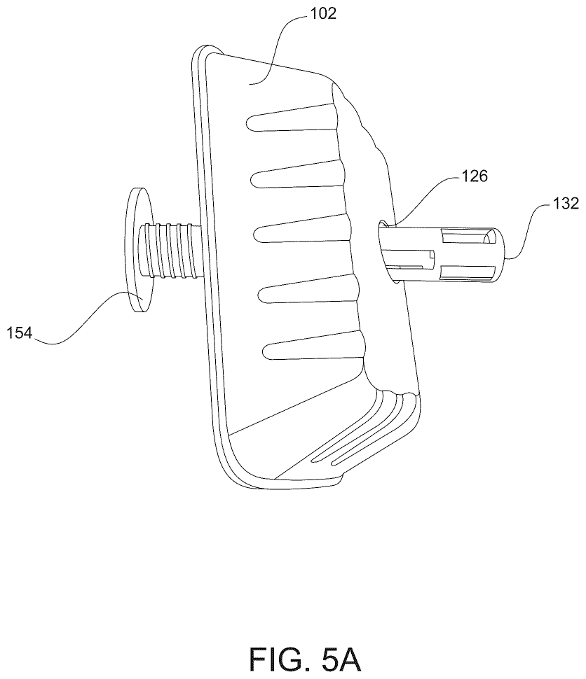

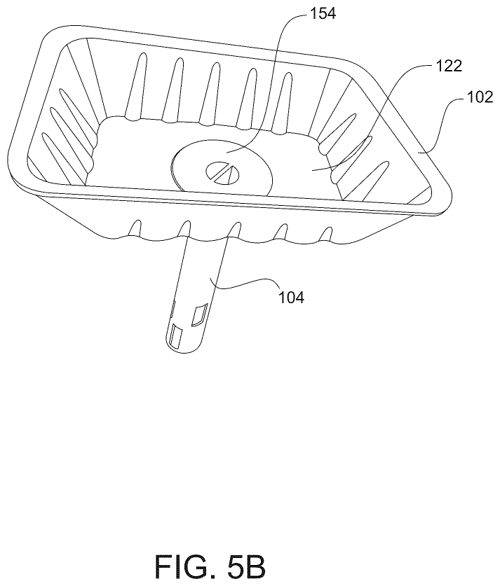

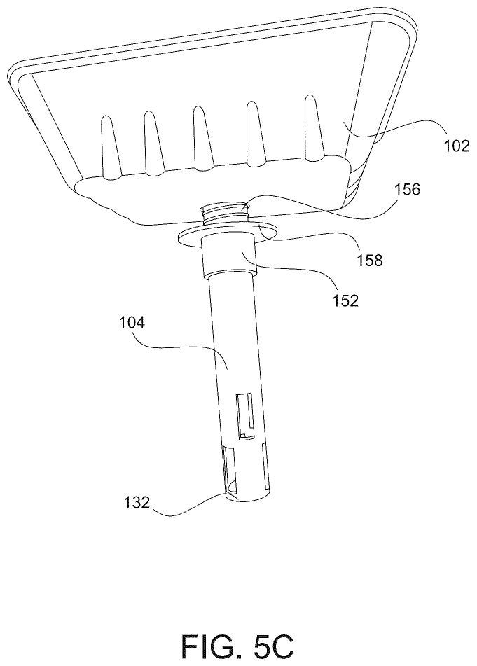

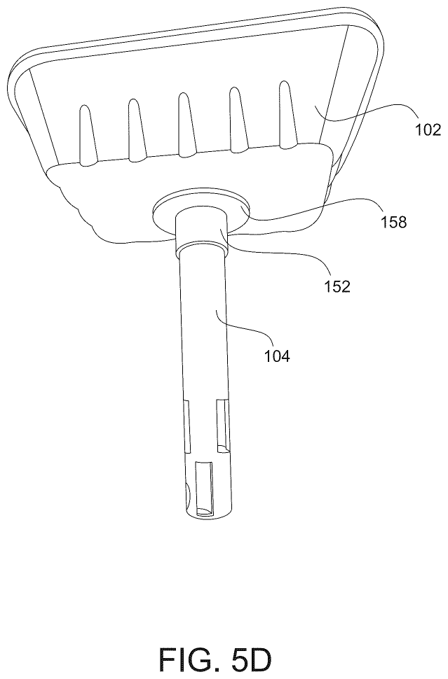

In a method of assembling the tubular member 104 and the fluid collection container 102, the distal end 132 of the tubular member 104 is first inserted through the drain opening 126 from the inside of the fluid collection container 102 towards the outside of the container 102, as shown in FIG. 5A. The tubular member 104 is then passed through the drain opening 126 until the underside of the flange 154 is in contact with the inside bottom surface 122 of the fluid collection container 102, as shown in FIG. 5B. Next, the distal end 132 of the tubular member 104 is inserted through the central opening of the attachment coupling 152 and the attachment coupling 152 is moved upward towards the proximal end 134 of the tubular member 104, as shown in FIG. 5C. Finally, the attachment coupling 152 is screwed onto the threaded portion 156 of the tubular member 104 such that the bottom surface 122 of the container 102 is sandwiched between the tubular member flange 154 and the attachment coupling flange 158, as shown in FIG. 5D. This mechanism for attaching the tubular member 104 to the fluid collection container 102 does not require the fluid collection container 102 to have a protruding spout, which allows the fluid collection container 102 to have a more compact size and shape for storage and shipping. In one example, the fluid collection container 102 may fold up or collapse. In another example, the fluid collection container 102 and the tubular member 104 are a fixed, single piece and the tubular member 104 may have a telescoping or collapsible arrangement so that the tubular member 104 and the fluid collection container 102 may fold up for storage.

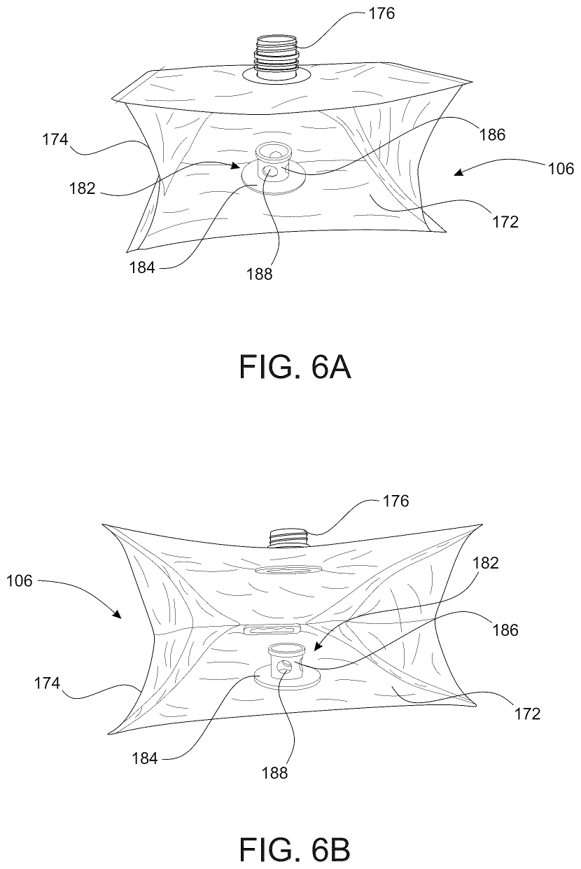

The distal end 132 of the tubular member 104 is configured for being coupled to a receptacle inside the fluid storage container 106. As shown in FIGS. 6A and 6B, the fluid storage container 106 includes an inlet opening 176 and an interior receptacle 182 that is aligned with the inlet opening 176. The distal end 132 of the tubular member 104 is coupled to the fluid storage container 106 by passing through the inlet opening 176 and attaching to the interior receptacle 182. The distal end 132 of the tubular member 104 may attach to the interior receptacle 182 using any effective connection mechanism, such as friction fit, snap fit, threaded connection, twist and lock, or the like. While the distal end 132 of the tubular member 104 and the interior receptacle 182 are coupled together in a fixed position, the inlet opening 176 of the fluid storage container 106 may move up and down relative to the tubular member 104, as illustrated in FIGS. 1A and 1B. FIG. 1A depicts the fluid storage container 106 in a collapsed configuration where the inlet opening 176 is positioned adjacent to the distal section 138 of the tubular member 104. As fluid is added to the fluid storage container 106, the fluid storage container 106 expands by itself to accommodate the fluid, and the inlet opening 176 rises relative to the tubular member 104, as shown in FIG. 1B.

The fluid storage container 106 is made of a nonporous, flexible material that is configured to expand, unfurl, unfold, and/or change shape by itself as fluid is added to the container 106. The material of the fluid storage container 106 may additionally be waterproof and heat resistant. For example, the fluid storage container 106 may be made of polyethylene, metallized biaxially oriented polyethylene terephthalate film (e.g., Mylar®), polyester film, coated paper, or the like, or a combination thereof. In one example, the fluid storage container 106 may be made of low-density polyethylene.

The fluid storage container 106 includes an interior surface 172, an exterior surface 174, and the inlet opening 176. Fluid enters the fluid storage container 106 through the inlet opening 176. The inlet opening 176 may be configured to accommodate a cap or similar sealing mechanism that can be removably attached to the inlet opening 176 so that the container 106 can be sealed closed in a manner that retains the liquid therein. In one example, the inlet opening 176 includes a protruding spout having external threads so that a cap having internal threads can be screwed onto the inlet opening 176 to thereby close the container 106. Alternatively, the inlet opening 176 may be closed using a friction fit cap or other similar sealing member.

The interior receptacle 182 is fixedly attached to the interior surface 172 of the fluid storage container 106 and includes a flange 184 and a protruding cylindrical holder member 186. The flange 184 is directly coupled to the interior surface 172 of the fluid storage container 106 in a fixed location. For example, the flange 184 may be heat fused to the interior surface 172 of the fluid storage container 106. In this example, the container 106 and the interior receptacle 182 may be made of the same material. In another example, the container 106 and the interior receptacle 182 may be a unitary, single piece made entirely of a single material.

The flange 184 is designed to support the tubular member 104 and the fluid collection container 102 during a fluid collection process. As such, the outer diameter of the flange 184 is large enough to stabilize the assembled apparatus. In one example, the outer diameter of the flange 184 is about 4.5-6.5 inches, and may be about 5-6 inches. The outer diameter of the flange 184 may be larger or smaller, depending on the size of the fluid collection container 102. Further, although the flange 184 is depicted as having a round cross-sectional shape, the invention is not limited to this shape. The flange 184 may be square, rectangular, triangular, hexagonal, or any other shape.

The interior receptacle 182 is aligned with the inlet opening 176 so that the tubular member 104 can be inserted into the fluid storage container 106 through the inlet opening 176 and then coupled to the interior receptacle 182. The protruding cylindrical holder member 186 may have an internal diameter that is substantially the same as, or slightly larger than, the outer diameter of the distal portion 138 of the tubular member 104. The distal end 132 of the tubular member 104 is configured to fit inside of the cylindrical holder member 186. The distal end 132 of the tubular member 104 may be coupled to the interior receptacle 182 by screwing, friction fit, snap fit, twist and lock, or any other coupling mechanism that allows the tubular member 104 to be removably coupled to the interior receptacle 182. The protruding cylindrical holder member 186 may include sidewall openings 188 to allow fluid to flow therethrough.

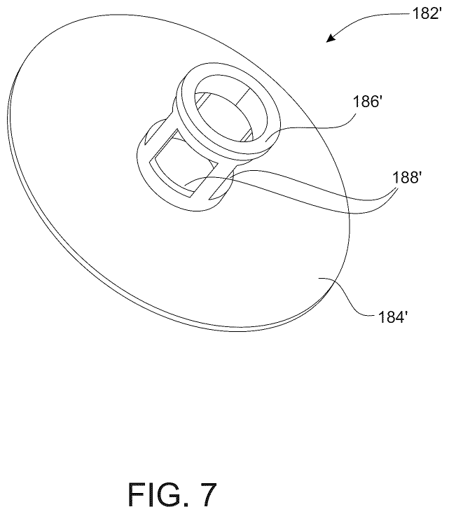

Another example of an interior receptacle 182′ is shown in FIG. 7. The interior receptacle 182′ includes sidewall openings 188′ that are square instead of round. Further, the interior receptacle 182′ includes a cylindrical holder member 186′ and a relatively large flange 184′.

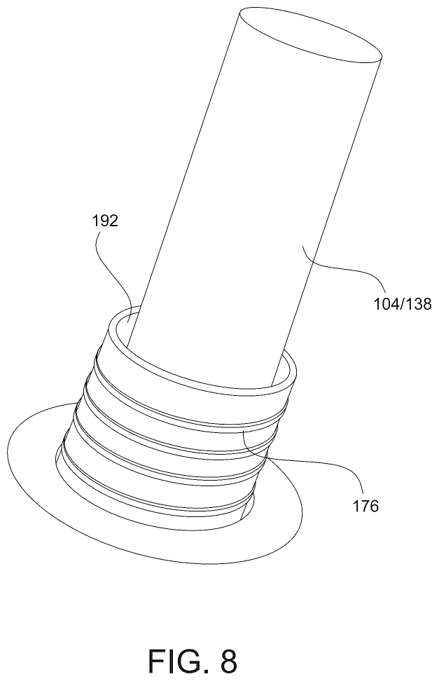

When the distal end of the tubular member 104 is coupled to the interior receptacle 182, there may be a gap 192 between the inlet opening 176 of the fluid storage container 106 and the outer surface of the distal portion 138 of the tubular member 104. This gap 192 is shown in FIG. 8. Having the gap 192 allows air to vent out of the fluid storage container 106 during the fluid collection process. Additionally or alternatively, the fluid storage container 106 may include a vent having a one-way valve that allows air to vent out of the fluid storage container 106. The gap 192 further allows the top portion of the fluid storage container 106 to rise relative to the tubular member 104 when liquid is added to the container 106 and the container is expanding.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A device for collecting and storing fluid, the device comprising:
a fluid collection container having a bottom surface, sidewalls, an open top, and a drain opening extending through the bottom surface;
a tubular member having a proximal end comprising a fluid inlet, a proximal section, a distal section, a distal end, an outer diameter, and a plurality of sidewall outlet openings in the distal section; and
a fluid storage container having an interior surface, an exterior surface, an inlet opening, and an interior receptacle fixedly coupled to the interior surface, the interior receptacle configured for coupling with the distal end of the tubular member, wherein the interior receptacle is aligned with the inlet opening so that the tubular member, when coupled to the interior receptacle, protrudes out of the inlet opening, and wherein the inlet opening has an inner diameter that is larger than the outer diameter of the tubular member.

2. The device of claim 1, wherein the fluid storage container is made of a flexible material and is configured to move between a collapsed configuration and an expanded configuration.

3. The device of claim 1, further comprising a gap between the inlet opening of the fluid storage container and the outer diameter of the tubular member when the tubular member is coupled to the interior receptacle, the gap configured for allowing air to pass therethrough during filling of the fluid storage container.

4. The device of claim 1, wherein the interior receptacle is heat fused to the interior surface of the fluid storage container.

5. The device of claim 1, wherein the fluid storage container is a bag made of a non-porous flexible material, such that a shape of the bag is configured to adjust as fluid is added to or removed from the bag.

6. The device of claim 5, wherein the non-porous flexible material is polyethylene, metallized biaxially oriented polyethylene terephthalate film, polyester film, or coated paper.

7. The device of claim 1, wherein the tubular member comprises a tubular member flange on the proximal end and an externally threaded section in the proximal section adjacent to the tubular member flange.

8. The device of claim 7, further comprising an attachment coupling comprising an attachment coupling flange and an internally threaded section adjacent to the attachment coupling flange, wherein the internally threaded section is configured to screw onto the externally threaded section of the tubular member.

9. The device of claim 8, wherein, when the tubular member and the fluid collection container are assembled for use, the tubular member protrudes out of the drain opening, the tubular member flange is in direct contact with the bottom surface of the fluid collection container, and the internally threaded section of the attachment coupling is coupled to the externally threaded section of the tubular member with a portion of the bottom surface of the fluid collection container sandwiched between the tubular member flange and the attachment coupling flange.

10. The device of claim 1, wherein the fluid collection container is collapsible such that the fluid collection container has a collapsed configuration and an unfolded, open configuration.

11. The device of claim 1, wherein the interior receptacle comprises an interior receptacle flange that is directly coupled to the interior surface of the fluid storage container, and a cylindrical holder member protruding from the interior receptacle flange, wherein the distal end of the tubular member is configured to fit within the cylindrical holder member.

12. A device for collecting and storing fluid, the device comprising:
a tubular member having a proximal end comprising a fluid inlet, a proximal section, a distal section, a distal end, an outer diameter, and a plurality of sidewall outlet openings in the distal section; and
a fluid storage container made of a nonporous flexible material configured to change shape as fluid is added to the fluid storage container, wherein the fluid storage container comprises an interior surface, an exterior surface, an inlet opening, and an interior receptacle fixedly coupled to the interior surface, the interior receptacle configured for coupling with the distal end of the tubular member, wherein the inlet opening has an inner diameter that is larger than the outer diameter of the tubular member such that the inlet opening is configured to rise relative to the tubular member as fluid is added to the fluid storage container.

13. The device of claim 12, further comprising a fluid collection container having an open top and a drain opening, wherein the fluid collection container is configured to funnel collected liquid through the drain opening and into the fluid inlet of the tubular member.

14. The device of claim 12, further comprising a gap between the inlet opening of the fluid storage container and the outer diameter of the tubular member when the tubular member is coupled to the interior receptacle, such that air may pass through the gap during filling of the fluid storage container.

15. The device of claim 12, wherein the interior receptacle is heat fused to the interior surface of the fluid storage container.
